(19) United States
(12) Patent Application Publication
(10) Pub. No.: US 2025/0287311 A1
(43) Pub. Date: Sep. 11, 2025

(54) SYSTEM AND APPARATUS SUITABLE FOR FACILITATING ENERGY EFFICENCY AND A PROCESSING/COMMUNICATION METHOD IN ASSOCIATION THERETO

(71) Applicant: Continental Automotive Technologies GmbH, Hannover (DE)

(72) Inventors: Shravan Kumar Kalyankar, Singapore (DE); David Gonzalez Gonzalez, Egelsbach (DE); Rikin Shah, Langen (DE); Reuben George Stephen, Singapore (SG); Andreas Andrae, Frankfurt am Main (DE)

(73) Assignee: Continental Automotive Technologies GmbH, Hannover (DE)

(21) Appl. No.: 18/860,012

(22) PCT Filed: Apr. 20, 2023
(86) PCT No.: PCT/EP2023/060341

§ 371 Date: Oct. 25, 2024

(30) Foreign Application Priority Data
Apr. 25, 2022 (DE) 10 2022 203 966.3

(51) Int. Cl. H04W 52/02

(52) U.S. Cl. CPC H04W 52/0235

(57) ABSTRACT

A receiver and a processor regulate periodicity of at least one wake-up signal. The receiver and processor are communicable with at least one user equipment. The receiver receives at least one input signal indicative of mobility status associated with the UE. The processor performs periodicity variance-based processing in association with the received input signal(s) so as to generate at least one output signal which can include at least one periodicity regulated WUS based on UE mobility status.

### CROSS-REFERENCE TO RELATED APPLICATIONS

The present application is a National Stage Application under 35 U.S.C. § 371 of International Patent Application No. PCT/EP2023/060341 filed on Apr. 20, 2023, and claims priority from German Patent Application No. 10 2022 203 966.1 filed on Apr. 25, 2022, in the German Patent and Trademark Office, the disclosures of which are herein incorporated by reference in their entireties.

### TECHNICAL FIELD

The present disclosure generally relates to one or both of a system and an apparatus suitable for facilitating energy efficiency and/or communication efficiency in association with, for example, a User Equipment (UE) usable for communication. The present disclosure further relates a processing/communication method which can be associated with the system and/or the apparatus.

### BACKGROUND

Generally, energy efficiency would be helpful/desired in communication networks. An example of a communication network would be a 3rd Generation Partnership Project (3GPP) 5G (fifth generation) New Radio (NR) standard-based telecommunications network.

Typically, techniques such as a Discontinuous Reception (DRX) mechanism and communication of Wake-Up Signals (WUS) can be utilized to assist in facilitating energy efficiency.

The present disclosure contemplates that conventional techniques (e.g., DRX and/or WUS) may not facilitate efficiency in an optimal manner.

The present disclosure contemplates that it would be helpful to address (or at least mitigate) one or more issues in relation to conventional techniques for facilitating efficiency.

### BRIEF SUMMARY

In accordance with an aspect of the disclosure, there is provided an apparatus which can, for example, be suitable for use for regulating periodicity of at least one wake-up signal (WUS), in accordance with an embodiment of the disclosure. Moreover, the apparatus can, for example, be communicable with at least one user equipment, in accordance with an embodiment of the disclosure.

In one embodiment, the apparatus can, for example, include a receiver and a processor. The receiver can, for example, be coupled to the processor.

The receiver can be configured to receive at least one input signal which can be indicative of mobility status associated with the User Equipment (UE), in accordance with an embodiment of the disclosure.

The processor can be configured to perform periodicity variance-based processing in association with the received input signal(s) so as to generate at least one output signal, in accordance with an embodiment of the disclosure. The output signal(s) can, for example, include at least one periodicity regulated WUS based on UE mobility status, in accordance with an embodiment of the disclosure.

In one embodiment, the input signal(s) can include at least one mobility indicator (MI) which can be indicative of UE mobility status (i.e., mobility status associated with the UE). Moreover, the mobility indicator(s) can, for example, be indicative of UE mobility status being either stationary (e.g., “stationary” mobility status) or non-stationary (e.g., “non-stationary” mobility status). In one example, periodicity of the WUS can be regulated (e.g., varied by manner of lengthening or shortening) in accordance with UE mobility status being either stationary or non-stationary (i.e., one of stationary and non-stationary). In one specific example, when UE mobility status is indicated as stationary, the processor can be configured to regulate periodicity of the WUS by manner of lengthening periodicity (e.g., as compared to periodicity of the WUS in association with UE mobility status being indicated as non-stationary). In another specific example, when UE mobility status is indicated as non-stationary, the processor can be configured to regulate periodicity of the WUS by manner of shortening periodicity (e.g., as compared to periodicity of the WUS in association with UE mobility status being indicated as stationary).

In another embodiment, the input signal(s) can include at least one mobility indicator (MI) which can be indicative of UE mobility status (i.e., mobility status associated with the UE). Moreover, the mobility indicators can, for example, be indicative of UE mobility status being any one of stationary, semi-stationary and non-stationary, or any combination thereof (i.e., stationary, semi-stationary and/or non-stationary; at least one of stationary, semi-stationary and non-stationary). In one example, periodicity of the WUS can be regulated (e.g., varied by manner of lengthening or shortening) in accordance with UE mobility status being stationary, semi-stationary or non-stationary (i.e., one of stationary, semi-stationary and non-stationary).

Moreover, in one embodiment, MI can, for example, be indicated (e.g., via at least one bit) by manner of any one of, or any combination of, the following:
UE capability message
UE assistant information
Medium Access Control (MAC) Control Element (CE)
PUCCH (Physical Uplink Control Channel).

The present disclosure contemplates that by manner of, for example, regulating WUS periodicity (e.g., regulating can be associated with varying periodicity by manner of shortening or lengthening), power/energy consumption can possibly be reduced (i.e., energy efficiency can possibly be facilitated) and/or signaling overhead can possibly be reduced (i.e., communication efficiency can possibly be facilitated), in accordance with an embodiment of the disclosure.

The above-described advantageous aspect(s) of the apparatus of the present disclosure can also apply analogously (all) the aspect(s) of a below described processing method of the present disclosure. Likewise, all below described advantageous aspect(s) of the processing method of the disclosure can also apply analogously (all) the aspect(s) of above described apparatus of the disclosure.

In accordance with an aspect of the disclosure, there is provided a processing method. The processing method can, for example, be associated with the abovementioned apparatus, in accordance with an embodiment of the disclosure.

The processing method can, for example, include an input step and a processing step, in accordance with an embodiment of the disclosure. In another embodiment, the processing method can, for example, further include an output step.

The input step can, for example, include receiving at least one input signal indicative of mobility status associated with at least one user equipment (UE).

The processing step can, for example, include processing the input signal(s) in a manner so as to generate at least one output signal. The output signal(s) can, for example, include at least one periodicity regulated wake-up signal (WUS) based on mobility status (e.g., of the UE), in accordance with an embodiment of the disclosure.

In one embodiment, the input signal(s) can be processed in association with periodicity variance based processing to generate the output signal(s).

In one example, the input signal(s) can include at least one mobility indicator (MI) indicative of UE mobility status (e.g., mobility status of the UE).

In a more specific example, the mobility indicator(s) can be indicative of UE mobility status being either stationary or non-stationary (i.e., one of stationary and non-stationary).

In another more specific example, the mobility indicator(s) can be indicative of UE mobility status being any one of stationary, semi-stationary and non-stationary, or any combination thereof (i.e., stationary, semi-stationary and/or non-stationary; at least one of stationary, semi-stationary and non-stationary).

The present disclosure contemplates that by manner of, for example, regulating WUS periodicity (e.g., regulating can be associated with varying periodicity by manner of shortening or lengthening), power/energy consumption can possibly be reduced (i.e., energy efficiency can possibly be facilitated) and/or signaling overhead can possibly be reduced (e.g., network energy efficiency can possibly be facilitated), in accordance with an embodiment of the disclosure.

The present disclosure further contemplates a computer program which can include instructions which, when the program is executed by a computer, cause the computer to carry out the input step, the processing step and/or the output step of the processing method. For example, the computer program can include instructions which, when the program is executed by a computer, cause the computer to carry out the input step and the processing step, in accordance with an embodiment of the disclosure.

The present disclosure yet further contemplates a computer readable storage medium having data stored therein representing software executable by a computer, the software including instructions, when executed by the computer, to carry out the input step, the processing step and/or the output step of the processing method. For example, the computer readable storage medium can have data stored therein representing software executable by a computer, the software including instructions, when executed by the computer, cause the computer to carry out the input step and the processing step, in accordance with an embodiment of the disclosure.

### BRIEF DESCRIPTION OF THE DRAWINGS

Embodiments of the disclosure are described hereinafter with reference to the following drawings.

FIG. 1 shows a system which can include at least one apparatus, according to an embodiment of the disclosure.

FIG. 2 shows the apparatus of FIG. 1 in further detail, according to an embodiment of the disclosure.

FIG. 3 shows a processing/communication method in association with the system of FIG. 1, according to an embodiment of the disclosure.

### DETAILED DESCRIPTION

The present disclosure generally contemplates the facilitation of network (e.g., in association with 5G standardization, 3GPP release 18 WI etc.) efficiency (e.g., energy/power efficiency and/or communication efficiency).

It is contemplated that a Next Generation Node B (gNB) in communication network may communicate one or more Wake-Up Signals (WUS) periodically. This may not be optimal as excessive energy/power consumption and/or excessive signaling overhead may be possible. Therefore, it may be helpful to address (or at least mitigate) the possibility of excessive power/energy consumption and/or the possibility of signaling overhead in association with communication associated with at least one gNB (e.g., communication of/with respect to WUS in relation to at least one gNB).

The present disclosure contemplates the possibility of a UE (User Equipment) mobility indicator (MI) which can, in one example, be communicated to at least one gNB for indicating whether the UE is stationary or non-stationary, in accordance with an embodiment of the disclosure. The present disclosure further contemplates the possibility of a UE (User Equipment) mobility indicator (MI) which can, in another example, be communicated to at least one gNB for indicating whether the UE is stationary, non-stationary or semi-stationary, in accordance with another embodiment of the disclosure.

In one embodiment, MI information can, for example, be indicated (via at least one bit) by manner of any one of, or any combination of, the following:
UE capability message
UE assistant information
Medium Access Control (MAC) Control Element (CE)
PUCCH (Physical Uplink Control Channel)

It is further contemplated that based on MI information, a gNB can, for example, be configured to group one or more UE into categories, in accordance with an embodiment of the disclosure. For example, a gNB can be configured to categorize one group of UE as “non-stationary” (i.e., a “non-stationary” category), another group of UE as “stationary” (i.e., a “stationary” category) and/or yet another group of UE as “semi-stationary” (i.e., a “semi-stationary” category), in accordance with an embodiment of the disclosure.

It is yet further contemplated that a gNB can, for example, be configured to regulate WUS periodicity (e.g., regulating can be associated with varying periodicity by manner of shortening or lengthening), in accordance with an embodiment of the disclosure. For example, a gNB can be configured to vary periodicity in association with the WUS in accordance with a category. In a more specific example, in association with the stationary category, a gNB can be configured to lengthen (e.g., as compared to the non-stationary category) the WUS period whereas the WUS period in association with the non-stationary category can be shortened (e.g., as compared to the stationary category).

The present disclosure contemplates that by manner of, for example, regulating WUS periodicity (e.g., regulating can be associated with varying periodicity by manner of shortening or lengthening), power/energy consumption can possibly be reduced (i.e., energy efficiency can possibly be facilitated) and/or signaling overhead can possibly be reduced (i.e., communication efficiency can possibly be facilitated) in association with, for example, communication associated with at least one gNB, in accordance with an embodiment of the disclosure. In this regard, network efficiency (e.g., energy/power efficiency and/or communication efficiency) can possibly be facilitated in association with communication in connection with at least one gNB, in accordance with an embodiment of the disclosure. In one example, energy efficiency (i.e., reduction of power/energy consumption) and/or communication efficiency (i.e., reduction of signaling overhead) can be facilitated in association with at least one gNB in connection with WUS communication (e.g., transmission of WUS from a gNB), in accordance with an embodiment of the disclosure.

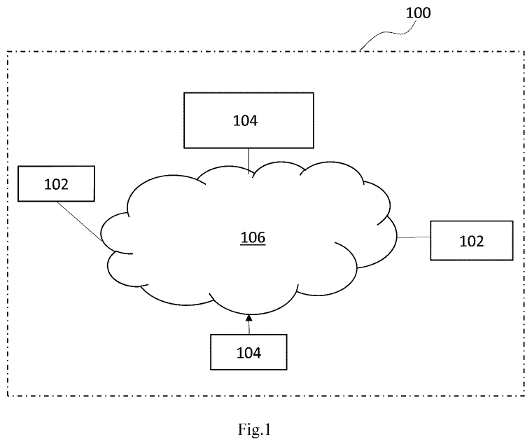

The foregoing will be discussed in further detail with reference to FIG. 1 to FIG. 3 hereinafter.

Referring to FIG. 1, a system 100 is shown, according to an embodiment of the disclosure. The system 100 can, for example, be suitable for one or both of facilitating energy/power efficiency and communication efficiency (i.e., energy/power efficiency and/or communication efficiency), in accordance with an embodiment of the disclosure.

As shown, the system 100 can include one or more apparatuses 102, at least one device 104 and, optionally, a communication network 106, in accordance with an embodiment of the disclosure.

The apparatus(es) 102 can be coupled to the device(s) 104. Specifically, the apparatus(es) 102 can, for example, be coupled to the device(s) 104 via the communication network 106, in accordance with an embodiment of the disclosure.

In one embodiment, the apparatus(es) 102 can be coupled to the communication network 106 and the device(s) 104 can be coupled to the communication network 106. Coupling can be by manner of one or both of wired coupling and wireless coupling. The apparatus(es) 102 can, in general, be configured to communicate with the device(s) 104 via the communication network 106, according to an embodiment of the disclosure.

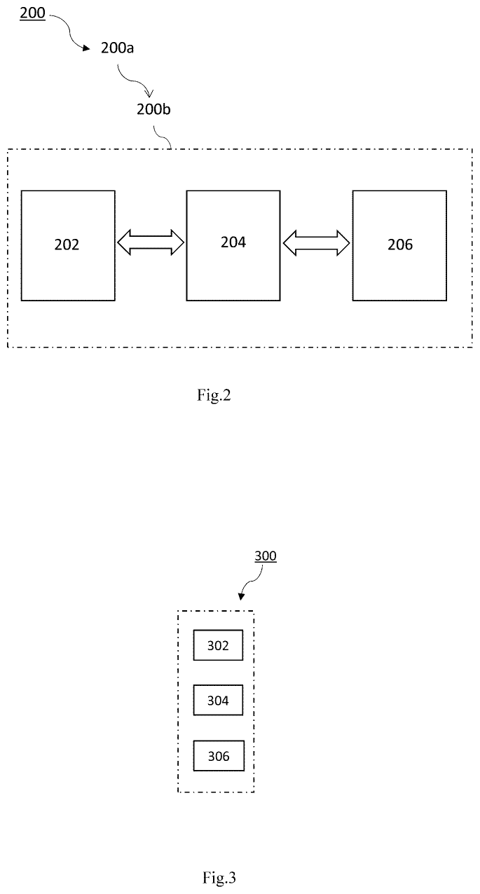

The apparatus(es) 102 can, for example, be associated with at least one gNB, in accordance with an embodiment of the disclosure. For example, the apparatus(es) 102 can correspond to one or more computers (e.g., an electronic device/module having computing capabilities) which can be configured to perform one or more processing tasks in association with at least one gNB. In a more specific example, the apparatus(es) 102 can, in one embodiment, include one or more processors (not shown) which can be configured to perform one or more processing tasks in association with at least one gNB. Generally, the processing task(s), in connection with the apparatus(es) 102, can, for example, include one or both of periodicity variance-based processing and categorization-based processing (i.e., periodicity variance-based processing and/or categorization-based processing), in accordance with an embodiment of the disclosure. In one embodiment, the apparatus(es) 102 can, for example, be configured to receive one or more input signals and perform at least one processing task on the input signal(s) in a manner so as to generate one or more output signals. The input signal(s) can, for example, be communicated from the device(s) 104, in accordance with an embodiment of the disclosure. The apparatus(es) 102 will be discussed later in further detail with reference to FIG. 2, according to an embodiment of the disclosure.

The device(s) 104 can, for example, correspond to one or more user equipment (UE) carrying one or more computers (e.g., an electronic device/module having computing capabilities such as an electronic mobile device which can be carried into a vehicle or an electronic module which can be installed in a vehicle, in accordance with an embodiment of the disclosure). The device(s) 104 can be configured to generate one or more input signals which can be communicated to the apparatus(es) 102 for further processing, in accordance with an embodiment of the disclosure. This will be discussed later in further detail in the context of an example implementation, in accordance with an embodiment of the disclosure.

The communication network 106 can, for example, correspond to an Internet communication network, a cellular-based communication network, a wired-based communication network, a Global Navigation Satellite System (GNSS) based communication network, a wireless-based communication network, or any combination thereof. Communication (e.g., between the apparatuses 102 and/or between the apparatus(es) 102 and the device(s) 104) via the communication network 106 can be by manner of one or both of wired communication and wireless communication.

Earlier mentioned, the apparatus(es) 102 can, for example, be configured to receive at least one input signal for processing to generate at least one output signal and the device(s) 104 can, for example, be configured to generate (and communicate) the input signal(s) to the apparatus(es) 102, in accordance with an embodiment of the disclosure. This will be discussed, in accordance with an embodiment of the disclosure, in the context of an example implementation hereinafter.

In the example implementation, a device 104 (referable to as a UE hereinafter in the context of the example implementation) can be carried in/by a vehicle. Moreover, an apparatus 102 (referable to as a “gNB” hereinafter in the context of the example implementation) can be coupled to the UE.

The UE can, for example, be coupled to at least one sensor (not shown) carried by the vehicle. Examples of the sensor(s) can include sensors which can be useful for determining self-motion such as a gyroscope and an accelerometer. Further examples of the sensor(s) can include a Global navigation satellite system (GNSS) sensor.

The UE can, for example, be configured to determine mobility status based on the sensor(s), in accordance with an embodiment of the disclosure. For example, the sensors can be configured to generate and communicate one or more sensor signals indicative of motion and/or position of the vehicle to the UE. The UE can be configured to receive and process the sensor signals to determine mobility status (e.g., non-stationary, stationary or semi-stationary etc.) associated with the vehicle. It is to be appreciated that mobility status associated with the vehicle can, for example, correspond to/be associated with mobility status of the UE (e.g., if a vehicle is non-stationary, the UE carried by the vehicle can correspondingly be considered to be non-stationary). Other examples associated with determination of mobility status (e.g., by the UE) can also be useful. For example, difference in received frequencies (reference signals of serving cells and neighboring cells) and/or building history can be helpful in determination of mobility status.

The UE can, for example, be configured to generate and communicate at least one input signal indicative of mobility status, in accordance with an embodiment of the disclosure.

In the example implementation, the UE can, for example, be configured to generate the input signal(s) based on the 3GPP TS 38.321 based standard/specification, in accordance with an embodiment of the disclosure. For example, the UE can be configured to modify/define (e.g., by manner of addition and/or changing) one or more bits associated with the MAC CE in physical uplink shared channel (PUSCH) Logical Channel ID (LCID) to generate the input signal(s). In a more specific example, at least one bit in the “Reserved” segment of the LCID (e.g., codepoint/index 35-44 per the LCID values for Uplink Shared Channel, UL-SCH) can be modified. This will be discussed in further detail based on a first scenario (e.g., a single-bit based scenario) and a second scenario (e.g., a multiple-bit based scenario) hereinafter.

In the first scenario, the input signal(s) can, for example, be generated by manner of an addition of a 1 bit based “mobility indicator” (a single bit MI) to MAC CE in PUSCH, in accordance with an embodiment of the disclosure. The LCID value(s) can, for example, be based on any reserved value between codepoint/index 35 to 44.

For example, a “0” value bit “mobility indicator” can be defined to indicate “stationary” mobility status (e.g., to indicate that the vehicle is not in motion) and a “1” value bit “mobility indicator” can be defined to indicate “non-stationary” mobility status (e.g., to indicate that the vehicle is in motion).

Specifically, in the example implementation, based on the first scenario and in an example situation where the UE (e.g., a low power UE) is mounted on a moving vehicle (e.g., a car or a train, etc.), a “1” value bit “mobility indicator” (e.g., MI=“1”) can be defined as a default value to indicate “non-stationary” mobility status, in accordance with an embodiment of the disclosure. Moreover, in the example implementation, based on the first scenario and in another example situation where the UE (e.g., a low power UE) is mounted on vehicle (e.g., a car or a train, etc.) which is not in motion (e.g., the vehicle is in a parked mode), a “0” value bit “mobility indicator” (e.g., MI=“0”) can be defined as a default value to indicate “stationary” mobility status, in accordance with an embodiment of the disclosure. In this regard, in the first scenario, at least one input signal indicative of whether the mobility status is “non-stationary” (e.g., MI=“1”) or whether the mobility status is “stationary” (e.g., MI=“0”) can, for example, be generated by the UE and communicated from the UE, in accordance with an embodiment of the disclosure. The input signal(s) can be communicated to at least one gNB for processing to generate at least one output signal as will be discussed later in further detail.

In the second scenario, the input signal(s) can be generated by manner of an addition of a 2-bit based “mobility indicator” (a multiple-bit MI) to MAC CE in PUSCH, in accordance with an embodiment of the disclosure. The LCID value(s) can, for example, be based on any reserved value between codepoint/index 35 to 44.

For example, a first two-bit (e.g., the first bit can be “0” and the second bit can be “0”) “mobility indicator” can be defined to indicate a first type mobility status, a second two-bit (e.g., the first bit can be “0” and the second bit can be “1”) “mobility indicator” can be defined to indicate a second type mobility status, a third two-bit (e.g., the first bit can be “1” and the second bit can be “0”) “mobility indicator” can be defined to indicate a third type mobility status and a fourth two-bit (e.g., the first bit can be “1” and the second bit can be “1”) “mobility indicator” can be defined to indicate a fourth type mobility status.

In this regard, in the second scenario, the first type mobility status can, for example, be indicative of/associated with perpetual immobility (e.g., the vehicle is considered to be perpetually not in motion), in accordance with an embodiment of the disclosure. Additionally, the second type mobility status can, for example, be indicative of/associated with, for example, transient mobility (e.g., the vehicle is currently non-stationary but previously stationary; in a more specific example, transient mobility can be in relation to a car, carrying the UE, which starts moving from a parked mode/position), in accordance with an embodiment of the disclosure. Furthermore, the third type mobility status can, for example, be indicative of/associated with transient immobility (e.g., the vehicle is currently stationary but previously non-stationary; in a more specific example, transient immobility can be in relation to a car, carrying the UE, being in a parked position/mode after completing a journey), in accordance with an embodiment of the disclosure. Moreover, the fourth type mobility status can, for example, be indicative of/associated with, for example, perpetual mobility (e.g., the vehicle is considered to be constantly in motion), in accordance with an embodiment of the disclosure.

In the example implementation, based on the second scenario, the first type mobility status can, for example, correspond to/be associated with “stationary” mobility status, in accordance with an embodiment of the disclosure. Additionally, the second type mobility status and the third type mobility status can, for example, correspond to/be associated with “semi-stationary” mobility status(es), in accordance with an embodiment of the disclosure. Furthermore, the fourth type mobility status can, for example, correspond to/be associated with “non-stationary” mobility status, in accordance with an embodiment of the disclosure. Yet furthermore, the “semi-stationary” mobility status(es) can, for example, include a first type semi-stationary mobility status and a second type semi-stationary mobility status, in accordance with an embodiment of the disclosure. The first type semi-stationary mobility status can, for example, be associated with the second type mobility status and the second type semi-stationary mobility status can, for example, be associated with the third type mobility status, in accordance with an embodiment of the disclosure.

In this regard, in the example implementation, based on the second scenario), in a first example situation where the UE (e.g., a low power UE) is mounted on vehicle (e.g., a car or a train, etc.) which has not been in motion for a predetermined period of time (e.g., 48 hours), a “00” value bit “mobility indicator” (e.g., MI=“00”) can be defined as a default value to indicate “stationary” mobility status, in accordance with an embodiment of the disclosure. Moreover, in a second example situation where the UE (e.g., a low power UE) is mounted on vehicle (e.g., a car or a train, etc.) which is considered to be in a temporary mobile state (e.g., the vehicle is detected to be in motion after being previously stationary for a predetermined period of time (e.g., 3 hours)), a “01” value bit “mobility indicator” (e.g., MI=“01”) can be defined as a default value to indicate “semi-stationary” mobility status, in accordance with an embodiment of the disclosure. Additionally, in a third example situation where the UE (e.g., a low power UE) is mounted on vehicle (e.g., a car or a train, etc.) which is considered to be in a temporary immobile state (e.g., the vehicle is detected to be stationary after being previously in motion for a predetermined period of time (e.g., 30 minutes)), a “10” value bit “mobility indicator” (e.g., MI=“10”) can be defined as a default value to indicate “semi-stationary” mobility status, in accordance with an embodiment of the disclosure. Furthermore, in a fourth example situation where the UE (e.g., a low power UE) is mounted on vehicle (e.g., a car or a train, etc.) which is considered to be in motion (e.g., the vehicle is detected to be in constant motion for a predetermined period of time (e.g., 1 hour)), a “11” value bit “mobility indicator” (e.g., MI=“11”) can be defined as a default value to indicate “non-stationary” mobility status, in accordance with an embodiment of the disclosure. The first type semi-stationary mobility status can, for example, be associated with the second type mobility status (e.g., MI=“01”) and the second type semi-stationary mobility status can, for example, be associated with the third type mobility status (e.g., MI=“10”), in accordance with an embodiment of the disclosure.

In this regard, in the example implementation, based on the second scenario, at least one input signal indicative of whether the mobility status is “non-stationary” (e.g., MI=“11”), whether the mobility status is “stationary” (e.g., MI=“00”) or whether the mobility status is “semi-stationary” (e.g., MI=“01” or MI=“10”) can, for example, be generated by the UE and communicated from the UE, in accordance with an embodiment of the disclosure. The input signal(s) can be communicated to at least one gNB for processing to generate at least one output signal as will be discussed in further detail hereinafter.

In the example implementation, a gNB can be configured to generate and communicate at least one control signal (e.g., which can be indicative of/correspond to UE capability enquiry). The control signal(s) can be communicated from the gNB to the UE for the purpose of, for example, requesting the UE to generate and communicate the input signal(s) based on one or both of the first scenario and the second scenario (i.e., the first scenario and/or the second scenario), in accordance with an embodiment of the disclosure. In one example, based on the control signal(s), the UE can be configured to generate and communicate at least one input signal based on a single-bit MI (e.g., a 1 bit-based MI per the first scenario), in accordance with an embodiment of the disclosure. In another example, based on the control signal(s), the UE can be configured to generate and communicate at least one input signal based on a multiple-bit MI (e.g., a 2 bits-based MI per the second scenario), in accordance with an embodiment of the disclosure. The input signal(s) communicated based on the first scenario can, for example, be referred to as a first type input signal(s). The input signal(s) communicated based on the second scenario can, for example, be referred to as a second type input signal(s). In another example, the present disclosure contemplates the possibility of the input signal(s) including/being associable with one or both of the first type input signal(s) and the second type input signal(s) (i.e., the first type input signal(s) and/or the second type input signal(s)), in accordance with an embodiment of the disclosure.

The gNB can be configured to receive the input signal(s) and process in the input signal(s) by manner of, for example, periodicity variance-based processing, in accordance with an embodiment of the disclosure. Periodicity variance-based processing can, for example, relate to variance in the wake-up period associated with at least one wake-up signal (WUS). It is contemplated that variance in the wake-up period associated with the WUS can, for example, be associated with/correspond to regulating periodicity of the WUS, in accordance with an embodiment of the disclosure.

In one example, in accordance with an embodiment of the disclosure, in the context of the first type input signal(s) (e.g., single-bit based mobility indicator), the gNB can be configured to perform periodicity variance-based processing in a manner such that:
if the input signal(s) received can be indicative (e.g., MI=0) of a “stationary” mobility status, the gNB can be configured to lengthen (e.g., in comparison to/relative to periodicity of the WUS in association with “non-stationary” mobility status) periodicity of the WUS. For example, in association with “stationary” mobility status, periodicity of the WUS can, for example, be lengthened to be 100 milliseconds (mS), in accordance with an embodiment of the disclosure.
if the input signal(s) received can be indicative (e.g., MI=1) of a “non-stationary” mobility status, the gNB can be configured to shorten (e.g., in comparison to/relative to periodicity of the WUS in association with “stationary” mobility status) periodicity of the WUS. For example, in association with “non-stationary” mobility status, periodicity of the WUS can, for example, be shortened to be 50 milliseconds (mS), in accordance with an embodiment of the disclosure.

In another example, in accordance with an embodiment of the disclosure, in the context of the second type input signal(s) (e.g., multiple-bits based mobility indicator), the gNB can be configured to perform periodicity variance-based processing in a manner such that:
if the input signal(s) received can be indicative (e.g., MI=00) of a “stationary” mobility status, the gNB can be configured to lengthen (e.g., in comparison to/relative to periodicity of the WUS in association with “non-stationary” mobility status) periodicity of the WUS. For example, in association with “stationary” mobility status, periodicity of the WUS can, for example, be lengthened to be 100 milliseconds (mS), in accordance with an embodiment of the disclosure.
if the input signal(s) received can be indicative (e.g., MI=11) of a “non-stationary” mobility status, the gNB can be configured to shorten (e.g., in comparison to/relative to periodicity of the WUS in association with “stationary” mobility status) periodicity of the WUS. For example, in association with “non-stationary” mobility status, periodicity of the WUS can, for example, be shortened to be 50 milliseconds (mS), in accordance with an embodiment of the disclosure.
if the input signal(s) received can be indicative (e.g., MI=01) of a first type “semi-stationary” mobility status, the gNB can be configured to shorten (e.g., in comparison to/relative to periodicity of the WUS in association with “stationary” mobility status) periodicity of the WUS. For example, in association with the first type “semi-stationary” mobility status, periodicity of the WUS can, for example, be shorted to be 25 milliseconds (mS), 50 mS or 75 mS in accordance with an embodiment of the disclosure. In this regard, it is appreciable that periodicity of the WUS in association with the first type “semi-stationary” mobility status can be shorter relative to periodicity of the WUS in association with the “stationary” mobility status, but can, for example, possibly be the same, longer or shorter relative to periodicity of the WUS in association with the “non-stationary” mobility status, in accordance with an embodiment of the disclosure.
if the input signal(s) received can be indicative (e.g., MI=10) of a second type “semi-stationary” mobility status, the gNB can be configured to lengthen (e.g., in comparison to/relative to periodicity of the WUS in association with “non-stationary” mobility status) periodicity of the WUS. For example, in association with the second type “semi-stationary” mobility status, periodicity of the WUS can, for example, be lengthened to be 75 milliseconds (mS), 100 mS or 125 mS in accordance with an embodiment of the disclosure. In this regard, it is appreciable that periodicity of the WUS in association with the second type “semi-stationary” mobility status can be longer relative to periodicity of the WUS in association with the “non-stationary” mobility status, but can, for example, possibly be the same, longer or shorter relative to periodicity of the WUS in association with the “stationary” mobility status, in accordance with an embodiment of the disclosure.

Appreciably, the present disclosure contemplates that higher number of bits (e.g., the first type input signal(s) compared with the second type input signal(s)) in association with the mobility indicator can possibly indicate mobility with higher granularity. This can, for example, possibly facilitate improved/increased flexibility in the sense that a gNB can have (more) flexibility in configuring different WUS periodicities based on various mobility status(es)/states associated with the UE.

In the above manner, it is appreciable that the input signal(s) can be communicated to at least one gNB for processing by manner of, for example, periodicity variance-based to generate at least one output signal, in accordance with an embodiment of the disclosure. In this regard, it is appreciable that the output signal(s) can include/correspond to/be associated with at least one wake-up signal (WUS) associable with regulated periodicity (e.g., periodicity being varied by manner of being, for example, lengthened or shortened, in accordance with mobility status), in accordance with an embodiment of the disclosure. In one embodiment, an output signal can include/correspond to a periodicity regulated WUS.

The present disclosure contemplates that by manner of, for example, regulating WUS periodicity (e.g., regulating can be associated with varying periodicity by manner of shortening or lengthening), power/energy consumption can possibly be reduced (i.e., energy efficiency can possibly be facilitated) and/or signaling overhead can possibly be reduced (i.e., communication efficiency can possibly be facilitated), in accordance with an embodiment of the disclosure.

The above-described advantageous aspect(s) of the system 100 of the present disclosure can also apply analogously (all) the aspect(s) of a below described apparatus 102 of the present disclosure. Likewise, all below described advantageous aspect(s) of the apparatus 102 of the disclosure can also apply analogously (all) the aspect(s) of above described system 100 of the disclosure.

The aforementioned apparatus(es) 102 will be discussed in further detail with reference to FIG. 2 hereinafter.

Referring to FIG. 2, an apparatus 102 is shown in further detail in the context of an example implementation 200, according to an embodiment of the disclosure.

In the example implementation 200, the apparatus 102 can correspond to an electronic module 200a which can be capable of performing one or more processing tasks in association with one or both of periodicity variance-based processing and categorization-based processing (i.e., periodicity variance-based processing and/or categorization-based processing), in accordance with an embodiment of the disclosure.

The electronic module 200a can, for example, correspond to/carry a computer capable of performing at least one processing task in association with at least one gNB, in accordance with an embodiment of the disclosure.

In one embodiment, the electronic module 200a can be capable of performing processing task(s) in association with periodicity variance-based processing, in accordance with an embodiment of the disclosure. In another embodiment, the electronic module 200a can be capable of performing processing task(s) in association with categorization-based processing, in accordance with an embodiment of the disclosure. In yet another embodiment, the electronic module 200a can be capable of performing processing task(s) in association with periodicity variance-based processing and categorization-based processing, in accordance with an embodiment of the disclosure.

The electronic module 200a can, for example, include a casing 200b. Moreover, the electronic module 200a can, for example, carry any one of a first module 202, a second module 204, a third module 206, or any combination thereof.

In one embodiment, the electronic module 200a can carry a first module 202, a second module 204 and/or a third module 206. In a specific example, the electronic module 200a can carry a first module 202, a second module 204 and a third module 206, in accordance with an embodiment of the disclosure.

In this regard, it is appreciable that, in one embodiment, the casing 200b can be shaped and dimensioned to carry any one of the first module 202, the second module 204 and the third module 206, or any combination thereof.

The first module 202 can be coupled to one or both of the second module 204 and the third module 206. The second module 204 can be coupled to one or both of the first module 202 and the third module 206. The third module 206 can be coupled to one or both of the first module 202 and the second module 204. In one example, the first module 202 can be coupled to the second module 204 and the second module 204 can be coupled to the third module 206, in accordance with an embodiment of the disclosure. Coupling between the first module 202, the second module 204 and/or the third module 206 can, for example, be by manner of one or both of wired coupling and wireless coupling. Each of the first module 202, the second module 204 and the third module 206 can correspond to one or both of a hardware-based module and a software-based module, according to an embodiment of the disclosure.

In one example, the first module 202 can correspond to a hardware-based receiver which can be configured to receive one or more input signals. The input signal(s) can, for example, be communicated from the device(s) 104 (e.g., a UE), in accordance with an embodiment of the disclosure.

The second module 204 can, for example, correspond to a hardware-based processor which can be configured to perform one or more processing tasks (e.g., in a manner so as to generate one or more output signals) in association with any one of, or any combination of, the following:
periodicity variance-based processing
categorization-based processing

In one example, at least one processing task associated with periodicity variance-based processing can be performed, in association with the received input signal(s), by the second module 204 in a manner so as to generate at least one output signal which can include/correspond to at least one periodicity regulated WUS. In another example, at least one processing task associated with categorization-based processing can be performed, in association with the received input signal(s), by the second module 204 to categorize one group of devices 104 (e.g., one group of UE) as “non-stationary” (i.e., a “non-stationary” category) and another group of devices 104 (e.g., another group of UE) as “stationary” (i.e., a “stationary” category) in a manner so to generate at least one output signal which can be indicative of category (e.g., “non-stationary” or “stationary” etc.) associated with at least one device 104. In yet another example, at least one processing task associated with categorization-based processing can be performed, in association with the received input signal(s), by the second module 204 to categorize one group of devices 104 (e.g., one group of UE) as “non-stationary” (i.e., a “non-stationary” category), another group of devices 104 (e.g., another group of UE) as “stationary” (i.e., a “stationary” category) and/or yet another group of devices 104 (e.g., yet another group of UE) as “semi-stationary” (i.e., a “semi-stationary” category) in a manner so to generate at least one output signal which can be indicative of category (e.g., “non-stationary,” “stationary” or “semi-stationary” etc.) associated with at least one device 104. In yet another example, at least one processing task associated with periodicity variance-based processing and categorization-based processing can be performed, in association with the received input signal(s), by the second module 204 in a manner so as to generate at least one output signal which can include/correspond to at least one periodicity regulated WUS and which can be indicative of category (e.g., “non-stationary,” “stationary” or “semi-stationary” etc.) associated with at least one device 104.

In this regard, it is appreciable that the input signal(s) can, for example, be processed in a manner (e.g., by manner of one or both of periodicity variance-based processing and categorization-based processing) so as to generate the output signal(s) which can include/correspond to/be associated with one or both of at least one periodicity regulated (e.g., periodicity being varied by manner of being, for example, lengthened or shortened, in accordance with mobility status) WUS and indication of category (e.g., “non-stationary,” “stationary” or “semi-stationary” etc.) associated with at least one device 104 (i.e., at least one periodicity regulated WUS and/or indication of category).

The third module 206 can correspond to a hardware-based transmitter which can be configured to communicate one or more output signals from the electronic module 200a. The output signal(s) can, for example, include/correspond to one or more periodicity-regulated (e.g., in association with shortening or lengthening of periodicity, as discussed with reference to FIG. 1, in accordance with an embodiment of the disclosure) wake-up signals (WUS). Moreover, the output signal(s) can, for example, be communicated from the electronic module 200a to, for example, one or both of at least one device 104 (e.g., a UE) and another apparatus 102 (at least one other gNB), in accordance with an embodiment of the disclosure.

The present disclosure contemplates the possibility that the first and second modules 202/204 can be an integrated software-hardware based module (e.g., an electronic part which can carry a software program/algorithm in association with receiving and processing functions/an electronic module programmed to perform the functions of receiving and processing). The present disclosure further contemplates the possibility that the first and third modules 202/206 can be an integrated software-hardware based module (e.g., an electronic part which can carry a software program/algorithm in association with receiving and transmitting functions/an electronic module programmed to perform the functions of receiving and transmitting). The present disclosure yet further contemplates the possibility that the first and third modules 202/206 can be an integrated hardware module (e.g., a hardware-based transceiver) capable of performing the functions of receiving and transmitting.

In view of the foregoing, it is appreciable that the present disclosure generally contemplates an apparatus 102 which can, for example, be suitable for use for regulating periodicity of at least one wake-up signal (WUS), in accordance with an embodiment of the disclosure. Moreover, the apparatus 102 can, for example, be communicable with at least one user equipment (e.g., a device 104), in accordance with an embodiment of the disclosure.

In one embodiment, the apparatus 102 can, for example, include a receiver 202 (e.g., the earlier discussed first module 202) and a processor 204 (e.g., the earlier discussed second module 204). The receiver 202 can, for example, be coupled to the processor 204.

The receiver 202 can be configured to receive at least one input signal which can be indicative of mobility status associated with the User Equipment (UE), in accordance with an embodiment of the disclosure.

The processor 204 can be configured to perform periodicity variance-based processing in association with the received input signal(s) so as to generate at least one output signal, in accordance with an embodiment of the disclosure. The output signal(s) can, for example, include at least one periodicity regulated WUS based on UE mobility status, in accordance with an embodiment of the disclosure.

In one embodiment, the input signal(s) can include at least one mobility indicator (MI) which can be indicative of UE mobility status (i.e., mobility status associated with the UE). Moreover, the mobility indicator(s) can, for example, be indicative of UE mobility status being either stationary (e.g., “stationary” mobility status) or non-stationary (e.g., “non-stationary” mobility status). In one example, periodicity of the WUS can be regulated (e.g., varied by manner of lengthening or shortening) in accordance with UE mobility status being either stationary or non-stationary (i.e., one of stationary and non-stationary). In one specific example, when UE mobility status is indicated as stationary, the processor 204 can be configured to regulate periodicity of the WUS by manner of lengthening periodicity (e.g., as compared to periodicity of the WUS in association with UE mobility status being indicated as non-stationary). In another specific example, when UE mobility status is indicated as non-stationary, the processor 204 can be configured to regulate periodicity of the WUS by manner of shortening periodicity (e.g., as compared to periodicity of the WUS in association with UE mobility status being indicated as stationary).

In another embodiment, the input signal(s) can include at least one mobility indicator (MI) which can be indicative of UE mobility status (i.e., mobility status associated with the UE). Moreover, the mobility indicators can, for example, be indicative of UE mobility status being any one of stationary, semi-stationary and non-stationary, or any combination thereof (i.e., stationary, semi-stationary and/or non-stationary; at least one of stationary, semi-stationary and non-stationary). In one example, periodicity of the WUS can be regulated (e.g., varied by manner of lengthening or shortening) in accordance with UE mobility status being stationary, semi-stationary or non-stationary (i.e., one or stationary, semi-stationary and non-stationary).

Moreover, in one embodiment, MI can, for example, be indicated (e.g., via at least one bit) by manner of any one of, or any combination of, the following:
UE capability message
UE assistant information
Medium Access Control (MAC) Control Element (CE)
PUCCH (Physical Uplink Control Channel).

The present disclosure contemplates that by manner of, for example, regulating WUS periodicity (e.g., regulating can be associated with varying periodicity by manner of shortening or lengthening), power/energy consumption can possibly be reduced (i.e., energy efficiency can possibly be facilitated) and/or signaling overhead can possibly be reduced (i.e., communication efficiency can possibly be facilitated), in accordance with an embodiment of the disclosure.

The above-described advantageous aspect(s) of the apparatus 102 of the present disclosure can also apply analogously (all) the aspect(s) of a below described processing/communication method of the present disclosure. Likewise, all below described advantageous aspect(s) of the processing/communication method of the disclosure can also apply analogously (all) the aspect(s) of above described apparatus 102 of the disclosure. It is to be appreciated that these remarks apply analogously to the earlier discussed system 100 of the present disclosure.

Referring to FIG. 3, a communication method (also referable to as a processing method) in association with the system 100 is shown, according to an embodiment of the disclosure.

The processing method 300 can, for example, be suitable for/capable of facilitating energy efficiency and/or communication efficiency, in accordance with an embodiment of the disclosure.

The processing method 300 can include any one of an input step 302, a processing step 304 and an output step 306, or any combination thereof, in accordance with an embodiment of the disclosure.

In one embodiment, the processing method 300 can include the input step 302. In another embodiment, the processing method 300 can include the input step 302 and the processing step 304. In another embodiment, the processing method 300 can include the input step 302, the processing step 304 and the output step 306. In yet another embodiment, the processing method 300 can include the processing step 304 and one or both of the input step 302 and the output step 306. In yet a further embodiment, the processing method 300 can include the input step 302, the processing step 304 and the output step 306. In yet a further additional embodiment, the processing method 300 can include the processing step 304. In yet another further additional embodiment, the processing method 300 can include any combination of the input step 302, the processing step 304 and the output step 306 (i.e., the input step 302, the processing step 304 and/or the output step 306).

With regard to the input step 302, one or more input signal(s) can be received. For example, the input signal(s) (e.g., a first type input signal(s) and/or a second type input signal(s)) can be received by an apparatus 102, in accordance with an embodiment of the disclosure.

With regard to the processing step 304, at least processing task associated with one or both of periodicity variance-based processing and categorization-based processing can be performed in a manner so as to generate one or more output signals which can include/correspond to/be associated with one or both of at least one periodicity regulated WUS and indication of category (e.g., “non-stationary,” “stationary” or “semi-stationary” etc.) associated with at least one device 104 (i.e., at least one periodicity regulated WUS and/or indication of category). For example, the apparatus 102 can be configured to process the received input signal(s) by manner of periodicity variance-based processing and/or categorization-based processing so as to generate the output signal(s) which can include/correspond to/be associated with at least one periodicity regulated WUS and/or indication of category, in accordance with an embodiment of the disclosure.

With regard to the output step 306, the output signal(s) can be communicated. For example, the output signal(s) can be communicated from the apparatus 102. In a more specific example, the output signal(s) can be communicated from the apparatus 102 to one or both of at least one device 104 and another apparatus 102, in accordance with an embodiment of the disclosure.

In view of the foregoing, it is appreciable that the present disclosure generally contemplates a communication/processing method 300.

The processing method 300 can, for example, include an input step 302 and a processing step 304, in accordance with an embodiment of the disclosure.

The input step 302 can, for example, include receiving (e.g., by an apparatus 102) at least one input signal indicative of mobility status associated with at least one user equipment (e.g., a device 104)

The processing step 304 can, for example, include processing (e.g., by an apparatus 102), the input signal(s) in a manner so as to generate at least one output signal. The output signal(s) can, for example, include at least one periodicity regulated wake-up signal (WUS) based on mobility status, in accordance with an embodiment of the disclosure.

In one embodiment, the input signal(s) can be processed in association with periodicity variance based processing to generate the output signal(s).

In one example, the input signal(s) can include at least one mobility indicator (MI) indicative of UE mobility status (e.g., mobility status of the UE).

In a more specific example, the mobility indicator(s) can be indicative of UE mobility status being either stationary or non-stationary (i.e., one of stationary and non-stationary).

In another more specific example, the mobility indicator(s) can be indicative of UE mobility status being any one of stationary, semi-stationary and non-stationary, or any combination thereof (i.e., stationary, semi-stationary and/or non-stationary; at least one of stationary, semi-stationary and non-stationary).

The present disclosure contemplates that by manner of, for example, regulating WUS periodicity (e.g., regulating can be associated with varying periodicity by manner of shortening or lengthening), power/energy consumption can possibly be reduced (i.e., energy efficiency can possibly be facilitated) and/or signaling overhead can possibly be reduced (i.e., communication efficiency can possibly be facilitated), in accordance with an embodiment of the disclosure.

The present disclosure further contemplates a computer program (not shown) which can include instructions which, when the program is executed by a computer (not shown), cause the computer to carry out the input step 302, the processing step 304 and/or the output step 306 as discussed with reference to the communication/processing method 300. For example, the computer program can include instructions which, when the program is executed by a computer, cause the computer to carry out the input step 302 and the processing step 304, in accordance with an embodiment of the disclosure.

The present disclosure yet further contemplates a computer readable storage medium (not shown) having data stored therein representing software executable by a computer (not shown), the software including instructions, when executed by the computer, to carry out the input step 302, the processing step 304 and/or the output step 306 as discussed with reference to the communication/processing method 300. For example, the computer readable storage medium can have data stored therein representing software executable by a computer, the software including instructions, when executed by the computer, cause the computer to carry out the input step 302 and the processing step 304, in accordance with an embodiment of the disclosure.

It should be appreciated that the embodiments described above can be combined in any manner as appropriate (e.g., one or more embodiments as discussed in the “Detailed Description” section can be combined with one or more embodiments as described in the “Summary of the Invention” section).

It should be further appreciated by the person skilled in the art that variations and combinations of embodiments described above, not being alternatives or substitutes, may be combined to form yet further embodiments.

In one example, as discussed earlier (e.g., in relation to the first and second scenarios), modification of/defining one or more bits (e.g., by the UE) in association with the PUSCH can be utilized for generating the input signal(s). It is contemplated that other examples are also useful. In one example, modification of one or more bits (e.g., by the UE) in association with PUCCH for generating the input signal(s) can be a possibility, in accordance with an embodiment of the disclosure. In another example, the UE can be configured to generate the input signal(s) based on a new PUCCH format which can carry one or more bits (e.g., a single bit or two bits) associated with the “mobility indicator”, in accordance with an embodiment of the disclosure.

In another example, as discussed earlier in relation to the example implementation of FIG. 1, a gNB (e.g., an apparatus 102) can be configured to generate and communicate at least one control signal which can be usable for the purpose of, for example, requesting the UE (e.g., a device 104) to generate and communicate the first type input signal(s) (e.g., based on the first scenario) and/or the second type input signal(s) (e.g., based on the second scenario). It is contemplated that, in one embodiment, generation and/or communication of the control signal(s) for the purpose of specifying the first type input signal or the second type input signal can be omitted. For example, UE capability can be reported when a UE has been registered (e.g., to the network). In a more specific example, in one embodiment, based on the control signal(s), a default set input signal(s) can be communicated based on reported UE capability (e.g., the control signal(s) can be communicable simply as a form of instruction to the UE to communicate the input signal(s) per se, without specifying the type of input signal(s)). In one example, the first type input signal(s) can be communicated by default (i.e., even with the second type input signal(s) being available) if the UE receives the control signal(s). In another example, the second type input signal(s) can be communicated by default (i.e., even with the first type input signal(s) being available) if the UE receives the control signal(s). In yet another example, the type of input signal(s) communicated by default can be based on availability (e.g., if the first type input signals are not available, the second type input signals can be communicated). In yet a further example, where both the first and second types input signal(s) are available, the first type input signal(s) and the second type input signal(s) can be communicated (in one example, sequentially, with the first type input signal(s) being communicated followed by the second type input signal(s), or vice versa; or in another example simultaneously, with both the first type and second type input signal(s) being communicated together).

In yet another example, the aforementioned WUS can be associated with a default periodicity and periodicity variance-based processing can be performed relative to/based on/with respect to such a default periodicity, in accordance with an embodiment of the disclosure. In one example, periodicity of the WUS can be lengthened (e.g., to 100 mS), based on periodicity variance-based processing, with respect to the default periodicity (e.g., 50 mS). In another example, periodicity of the WUS can be shortened (e.g., to 25 mS), based on periodicity variance-based processing, with respect to the default periodicity (e.g., 50 mS).

In yet a further additional example, the present disclosure contemplates the possibility that periodicity of the WUS in association with the first type “semi-stationary” mobility status and periodicity of the WUS in association with the second type “semi-stationary” mobility status can, for example, be similar/same (e.g., 75 mS), in accordance with an embodiment of the disclosure.

In yet another further additional example, as discussed earlier in relation to the example implementation of FIG. 1, periodicity of a WUS can be lengthened in association with “stationary” mobility status and periodicity of a WUS can be shortened in association with “non-stationary” mobility status, in accordance with an embodiment of the disclosure. The present disclosure contemplates the possibility that the converse may be applicable in one or more differing situations/applications. For example, periodicity of a WUS can be shortened in association with “stationary” mobility status and periodicity of a WUS can be lengthened in association with “non-stationary” mobility status, depending on application requirement(s), in accordance with an embodiment of the disclosure. Analogously, with regard to the earlier discussed first type “semi-stationary” mobility status (e.g., MI=01), periodicity of the WUS can be lengthened, if appropriate (i.e., depending on application requirement(s)), with accordance with an embodiment of the disclosure. Further analogously, with regard to the earlier discussed second type “semi-stationary” mobility status (e.g., MI=10), the periodicity of the WUS can be shortened, if appropriate (i.e., depending on application requirement(s)), with accordance with an embodiment of the disclosure.

In yet another further additional example, the present disclosure contemplates frequency of a UE report (e.g., to the network) concerning mobility status. In one example, the UE report can be communicated during initial access procedure (e.g., in association with UE capability message). In another example, the UE report can be communicated in the form of a periodic status report. In a specific example, for the purpose of communicating a periodic status report, a timer (e.g., a periodic indication timer) can be configured such that when the periodic indication timer expires, the UE report can be communicated to the gNB and restarted (e.g., the period indication timer is restarted at UE) after the UE report has been communicated. Moreover, in the specific example, the maximum value associated with the periodic indication timer can be set to “infinity” (i.e., which means it can be disabled). Additionally, it is contemplated that the periodic indication timer can be started when during initial access procedure (e.g., when mobility indicator is reported in association with the UE capability message).

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

1. An apparatus suitable for use for regulating periodicity of at least one wake-up signal (WUS) and communicable with at least one user equipment (UE), the apparatus comprising:
a receiver configured to receive at least one input signal indicative of mobility status associated with the at least one UE; and
a processor coupled to the receiver, the processor being configured to perform periodicity variance-based processing in association with the at least one received input signal so as to generate at least one output signal comprising at least one periodicity regulated WUS based on UE mobility status.

2. The apparatus according to claim 1, the at least one input signal comprising at least one mobility indicator indicative of UE mobility status.

3. The apparatus according to claim 2, the at least one mobility indicator being indicative of UE mobility status being one of stationary and non-stationary.

4. The apparatus according to claim 3, periodicity of the at least one WUS being regulated in accordance with UE mobility status being one of stationary and non-stationary.

5. The apparatus according to claim 4, wherein when UE mobility status is indicated as stationary, the processor is configured to regulate periodicity of the WUS by manner of lengthening periodicity as compared to periodicity of the WUS in association with UE mobility status being indicated as non-stationary.

6. The apparatus according to claim 4, wherein when UE mobility status is indicated as non-stationary, the processor is configured to regulate periodicity of the WUS by manner of shortening periodicity as compared to periodicity of the WUS in association with UE mobility status being indicated as stationary.

7. The apparatus according to claim 2,
wherein the at least one mobility indicator is indicative of UE mobility status being at least one of stationary, semi-stationary and non-stationary, or
wherein periodicity of the at least one WUS being regulated in accordance with UE mobility status being one of stationary, semi-stationary and non-stationary.

8. The apparatus according to claim 2, wherein the at least one mobility indicator being indicated by at least one of:
UE capability message;
UE assistant information;
Medium Access Control Control Element; and
Physical Uplink Control Channel.

9. A processing method comprising:
receiving, by an apparatus, at least one input signal indicative of mobility status associated with at least one user equipment (UE);
processing, by an apparatus, the at least one input signal to generate at least one output signal comprising at least one periodicity regulated wake-up signal (WUS) based on mobility status, wherein the apparatus regulates periodicity of at least one wake-up signal and communicates with at least one user equipment, the apparatus comprising:
a receiver configured to receive the at least one input signal indicative of mobility status associated with the at least one UE; and
a processor coupled to the receiver, the processor being configured to perform periodicity variance-based processing in association with the at least one received input signal to generate the at least one output signal comprising at least one periodicity regulated WUS based on UE mobility status.

10. The processing method according to claim 9, the at least one input signal being processed based on periodicity variance to generate the at least one output signal.

11. The processing method according to claim 9, the at least one input signal comprising at least one mobility indicator indicative of UE mobility status.

12. The processing method according to claim 11, the at least one mobility indicator being indicative of UE mobility status being one of stationary and non-stationary.

13. The processing method according to claim 11, the at least one mobility indicator being indicative of UE mobility status being at least one of stationary, semi-stationary and non-stationary.

14. (canceled)

15. Anon-transitory computer readable storage medium having stored thereon computer-executable instructions that, when executed by the computer, perform operations comprising:
at least one of:
receiving, by an apparatus, at least one input signal indicative of mobility status associated with at least one user equipment (UE); and
processing, by an apparatus, the at least one input signal to generate at least one output signal comprising at least one periodicity regulated wake-up signal (WUS) based on mobility status;
wherein the apparatus regulates periodicity of at least one wake-up signal and communicates with at least one user equipment, the apparatus comprising:
a receiver configured to receive the at least one input signal indicative of mobility status associated with the at least one UE; and
a processor coupled to the receiver, the processor being configured to perform periodicity variance-based processing in association with the at least one received input signal to generate the at least one output signal comprising at least one periodicity regulated WUS based on UE mobility status.

16. The computer readable storage medium according to claim 15, the at least one input signal being processed based on periodicity variance to generate the at least one output signal.

17. The computer readable storage medium according to claim 15, the at least one input signal comprising at least one mobility indicator indicative of UE mobility status.

18. The computer readable storage medium according to claim 17, the at least one mobility indicator being indicative of UE mobility status being one of stationary and non-stationary.

19. The computer readable storage medium according to claim 17, the at least one mobility indicator being indicative of UE mobility status being at least one of stationary, semi-stationary and non-stationary.
